(19) United States
(12) Patent Application Publication
(10) Pub. No.: US 2016/0368084 A1
(43) Pub. Date: Dec. 22, 2016

(54) WORKING APPARATUS

(71) Applicant: KUKA SYSTEMS GMBH, Augsburg (DE)

(72) Inventors: Thomas HENNEKE, Peiting (DE); Manfred HÖLSCHER, Ziemetshausen (DE)

(21) Appl. No.: 14/898,929

(22) PCT Filed: Jun. 11, 2014
(86) PCT No.: PCT/EP2014/062084

§ 371 Date: Dec. 16, 2015

(30) Foreign Application Priority Data
Jun. 17, 2013 (DE) 20 2013 102 577.1

(51) Int. Cl. B23K 26/035; B23K 37/04; B23K 26/24; B23K 26/08; B23K 26/042

(52) U.S. Cl. CPC B23K 26/037; B23K 26/0884; B23K 26/042; B23K 26/24; B23K 37/0461

(57) ABSTRACT

A beam-operated joining apparatus (1) for working a workpiece (4) using a laser beam (2). The beam-operated joining apparatus (1) contains a working tool (3) which is mobile in a direction of transport (11) and has a working head (7) emitting the laser beam (2) and a pressing device including a pressing element (28) arranged at the level of the laser beam (2) and to the sides thereof. At least one further pressing element (29, 30) is arranged adjacent tp (in front of and/or behind) the pressure element (28).

### CROSS REFERENCE TO RELATED APPLICATIONS

This application is a United States National Phase Application of International Application PCT/EP2014/062084 filed Jun. 11, 2014 and claims the benefit of priority under 35 U.S.C. §119 of German Utility Model DE 20 2013 102 577.1 filed Jun. 17, 2013, the entire contents of which are incorporated herein by reference.

### FIELD OF THE INVENTION

The present invention pertains to a working apparatus, especially a beam-operated joining apparatus for working a workpiece with a high-energy beam, especially laser beam, wherein the working apparatus has a working tool movable in a direction of transport with a working head emitting the beam and with a pressing device with a pressing element, which is arranged at the level of and to the side of the beam.

### BACKGROUND OF THE INVENTION

Such a beam-operated joining apparatus is known from DE 20 2010 008 808 U1 or DE 201 03 411 U1. It is used to join, especially weld or solder workpieces with a laser beam and has a joining tool movable by an industrial robot in a direction of transport with a working head emitting the laser beam and with a pressing device with a pressing element, which is arranged, when viewed in the direction of transport, at the level of and laterally next to the laser beam. The beam-operated joining apparatus shown in DE 20 2010 008 808 U1 is used to weld or solder roof parts at side wall parts of a vehicle body.

### SUMMARY OF THE INVENTION

An object of the present invention is to further improve the prior-art working technique, especially the beam-operated joining apparatuses.

The working technique according to the invention i.e., the working apparatus and the working method, can lead, thanks to improved pressing technique, to working results of better quality, especially better joining qualities.

The working technique is especially suitable for joining multipart workpieces, in which the workpiece parts are oriented in some areas obliquely to the direction in which the working tool is pressed and are supported on one another along this oblique plane. The workpiece parts can be pressed and clamped to one another by means of the pressing device and the plurality of pressing elements at a plurality of points and hence more uniformly as well as in a larger area. Any possible tolerances of the workpiece parts can be compensated as a result better and over a larger area along the working path. The working result, especially a joint seam, can be more uniform due to this compensation and has a better technical and optical quality.

The pressing device with the at least two, preferably three or more pressing elements has the advantage that it can be optically adapted to the particular clamping and pressing needs of the workpiece parts. The pressing elements can be activated or deactivated for this for pressing individually and preferably independently from one another. For example, they can be fed into a pressing position at the workpiece or workpiece part for activation and pressed with a clamping force F. They can be moved for deactivation into a pressing-free inoperative position or left in the pressing position and the power operating them can be switched off.

Pressing the workpiece parts in the immediate vicinity of the point at which the beam reaches the workpiece and of the joining point is advantageous on the end areas or points of a working path, especially of a joint seam, that are especially critical for joining. It may be advantageous in the inner or central area of the path in certain applications, e.g., in case of the aforementioned roof welding operations, to press in the direction of transport of the working tool at a spaced location only in front of or behind the working or joining point. The tolerance compensation and the accompanying deformation of the workpiece parts becomes more uniform due to the correspondingly extended pressing and clamping area, so that an improved working result, especially improved quality of the joint seam, will be obtained. The optical quality, in particular, is possibly of primary significance in these central areas of the path.

The pressing or clamping force applied by the pressing element or pressing elements can be controlled in a sensitive manner and also regulated, if necessary, by means of a suitable sensor system. Boundary conditions dictated by the workpiece, e.g., the preservation of the surface finish or the like, may also be taken into account in this connection.

Further, it is advantageous for reasons of quality if one or more and preferably all pressing elements are designed as pressing rollers, which can roll on the workpiece part on which they act without damaging the surface. In addition, it is advantageous for this to provide a rotating drive. This drive may be synchronized with the transport or feed motion and the rolling velocity caused thereby.

An especially simple embodiment provides for a mechanical rotating drive with derivation of the rotary motion from a friction roller, which is likewise pressed onto the workpiece part in a frictionally engaged manner and which converts the usually translatory transport or feed motion into a rotary motion especially gently for the workpiece part and drives, via this, one or another of the pressing rollers by means of an axle connection. The friction roller, which is present as one roller or as a plurality of rollers, may be arranged at a spaced location from the working point or working path for thermal shielding. The pressing rollers can have, as a result, a more suitable design for the pressing task proper in terms of material, shape or the like, which can also withstand the thermal effects and is insensitive to any possible effects of the process, e.g., blobs of melted filler metal or melted solder, gases, etc.

The working technique being claimed may be used for a great variety of working methods with a high-energy beam. Laser beam working is preferred. There are special advantages in this connection in the joining technique with a laser beam or another high-energy beam, e.g., an ion or plasma beam. Preferred joining techniques are soldering or welding. Special advantages are offered especially by beam-operated soldering, preferably laser beam-operated soldering, for the above-described applications in car body manufacturing.

The present invention is shown schematically and as examples in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a cut-away schematic side view of a working apparatus with an industrial robot and with a working tool;

FIG. 2 is a schematic cross-sectional view of a joining point at two workpiece parts and of the working tool;

FIG. 3 is a schematic view of a pressing device of the working tool in one of different operating positions;

FIG. 4 is a schematic view of a pressing device of the working tool in another of different operating positions;

FIG. 5 is a schematic view of a pressing device of the working tool in another of different operating positions;

FIG. 6 is a schematic view of a pressing device of the working tool in another of different operating positions;

FIG. 7 is a schematic view of a pressing device of the working tool in another of different operating positions; and

FIG. 8 is a schematic side view of a pressing roller with a rotating drive.

### DESCRIPTION OF THE PREFERRED EMBODIMENTS

The present invention pertains to a working apparatus (1) and to a method for working a workpiece (4) with an emitted high-energy beam (2). The working apparatus (1) is preferably designed as a beam-operated joining apparatus and the method as a beam-operated joining method.

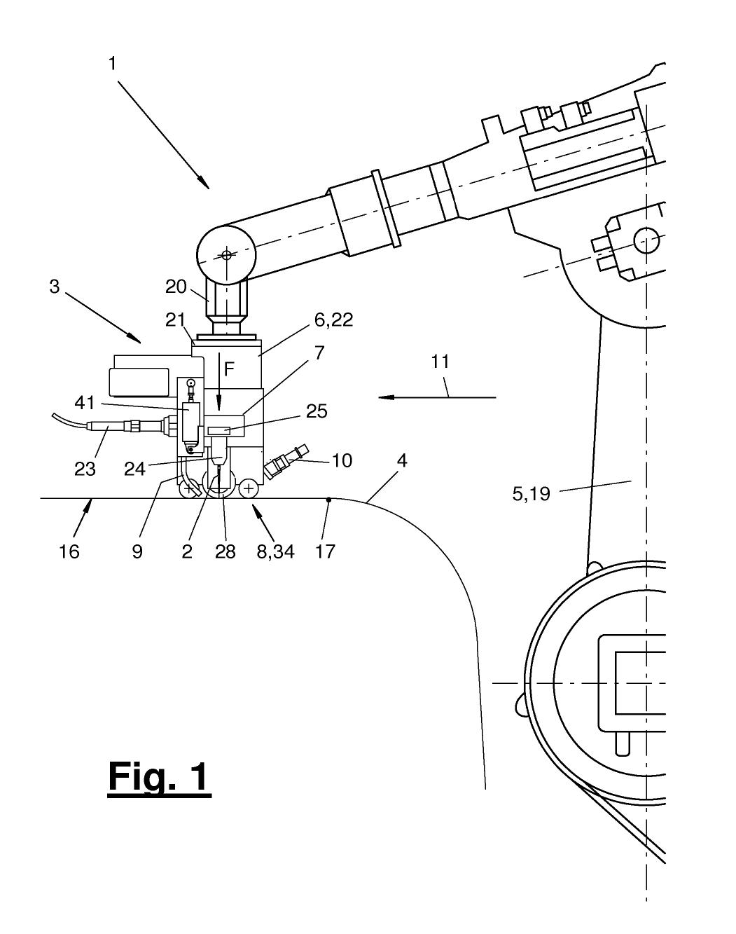

In a cut-away schematic side view, FIG. 1 shows a working apparatus (1) designed as a beam-operated joining apparatus. The working apparatus (1) operates with a high-energy beam (2), which is designed as a laser beam in his exemplary embodiment. The features of the beam-operated joining apparatus (1) and of the high-energy beam (2), which will be described below, correspondingly also apply to other types of working apparatuses (1) and other high-energy beams (2).

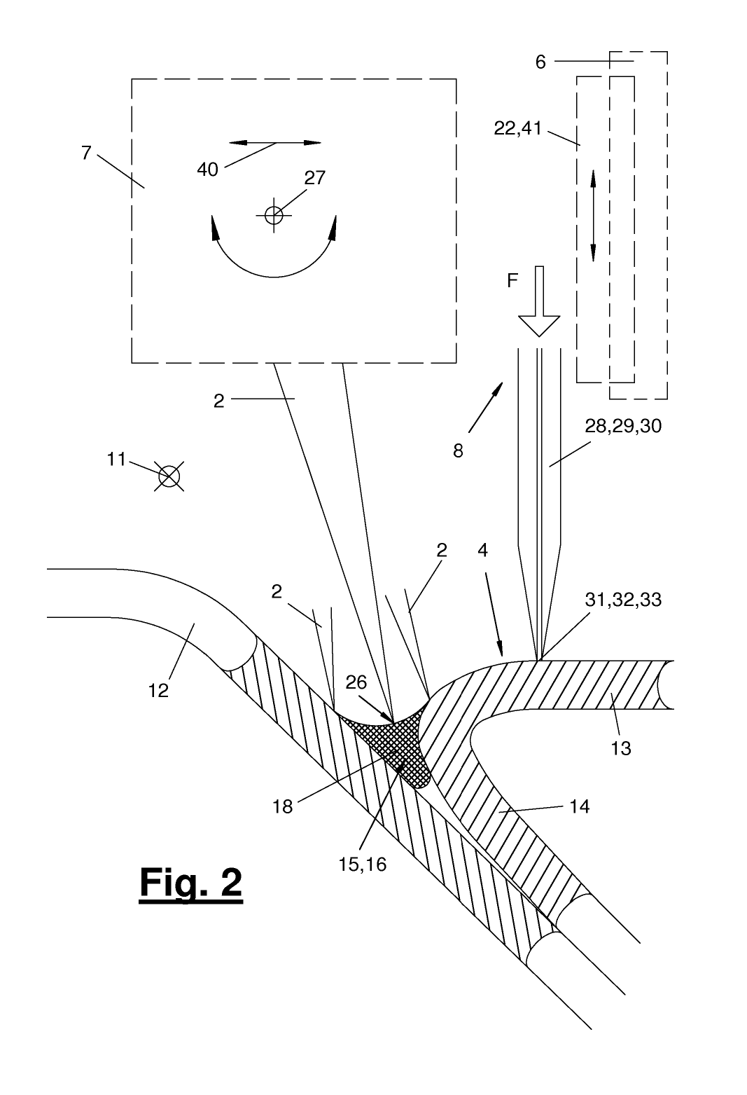

The beam-operated joining apparatus (1) shown in FIG. 1 and in other drawings is designed as a welding apparatus or soldering apparatus and is used to join a workpiece (4) possibly comprising two or more workpiece parts (12, 13). The workpiece parts (12, 13) may be, e.g., according to FIG. 2, panels of a body shell of a vehicle. One panel (12) is, e.g., a part of a side wall and the other panel (13) is a roof panel, which has a bent edge (14) and is in contact with same with a section of the side wall panel (12) directed obliquely to the vertical space axis. In the embodiment shown, the panels (12, 13) are soldered to one another at the contact point. A wedge or a groove is formed at this contact or connection point, which will hereinafter also be called joining point (15), between the panel (12) and the unbent panel edge (14), which can be filled by a joining aid (18), e.g., a solder (18) or a filler metal wire. The joining aid (18) and optionally the panels are melted by the laser beam (2) and connected to one another, especially soldered or welded.

The panels (12, 13) extend in a direction at right angles to the drawing plane of FIG. 2, and a working path or joint seam (16), especially soldering seam or weld seam, is formed in the same direction in the process.

The beam-operated joining apparatus (1) shown in FIG. 1 has a working tool (3) and a manipulating device (5) for guiding same. The working tool (3) is preferably designed as a beam-operated joining tool and as a laser soldering tool in the exemplary embodiment being shown. The features described below correspondingly also apply to other variants of working tools (3).

The manipulating device is movable along a plurality of axes and may have any desired number and arrangement of rotatory and/or translatory axes of motion. The manipulating device (5) is preferably designed as an industrial robot (19) and has a driven member (20). In the embodiment being shown, it is an articulated arm robot with six axes of rotation. It comprises a base, a rocker, which is mounted thereon rotatably and pivotably and which carries at its free end a pivotably mounted arm or extension arm, at the end of which the driven member (20) is arranged. The latter is designed, e.g., as a so-called robot hand, which has three rotatory axes in the exemplary embodiment being shown. The driven member (20) has a rotating driven flange, which is connected to a connection (21) at the beam-operated joining tool (3) directly or via the intermediary of a change-over coupling. The connection may be detachable.

The working tool, especially beam-operated joining tool (3), has a working head (7), especially a working head, which emits the laser beam (2) and is directed towards the workpiece (4). The working tool (3) has, furthermore, a pressing device (8) with a plurality of pressing elements (28, 29, 30), which can be fed against the workpiece (4) and pressed on with a pressing force (F). In addition, the working tool (3) may have a feeding device (9) for said aid (18) and optionally a sensor system (10).

The working head (7) has a beam feeding device (23), e.g., a fiber optic cable, an optical system (25) and a beam outlet (24), from which the laser beam (2) exits to the workpiece (4). The optical system (25) may be adjustable. It may have, e.g., an autofocus device for axially displacing the beam focus and/or a scanner optical system with lenses and/or mirrors, which can be adjusted, especially pivoted, in a controlled manner, in order to be able to be deflected in terms of its exit angle.

The laser beam (2) has a point of impact (26) on the workpiece (4) on which it falls or on one or both workpiece parts (12, 13) as well as the joining aid (18) that may be present. The focus may be located above or below the point of impact (26).

The manipulating device (5) moves the working tool (3) in a direction of transport or feed direction (11), which is directed along the desired working path (16). To make it possible to exactly follow the preset working path (16), the working tool (3), especially the working head (7), may have a tracking device (40), which makes possible a tracking motion indicated in FIG. 2 at right angles to the direction of transport (11) and to the working path (16). The working head (7) may, in addition, be designed or arranged such that it emits the laser beam (2) vertically downward or in an oblique direction.

Furthermore, the working head (7) may have an oscillating device (27) indicated in FIG. 2 with an oscillation axis direction along the direction of transport (11). As a result, the laser beam (2) can perform controlled oscillating motions at right angles to the direction of transport (11) and to the working path (16) during the feed. The oscillating device (27) may be formed by the aforementioned scanner optical system. As an alternative or in addition, it may be formed by a mechanical rotating device.

To search for and track the working path (16) on the workpiece, the feeding device (9) for said aid (18) may be used as a tactile sensor interacting with a corresponding, e.g., unpowered tracking device (40). As an alternative or in addition, a preferably contactless sensor system (10) may be used to search for or track the working path (16) and to control the driven tracking device (40). Quality control of the working process, especially of a joint seam (16), may also be performed with a sensor system (10).

The working tool (3) has, furthermore, a frame (6), on which the connection (21) is arranged and which may optionally also contain a media coupling. The frame (6) may have a principal plane or an attachment plane, which is directed along the direction of transport (11).

Furthermore, a carriage (22), which, controlled with an adjusting device (41), can be moved to and fro in the direction of the workpiece (4), may be arranged and guided at the frame (6). This arrangement may be designed, for example, corresponding to DE 20 2010 008 808 U1. The working head (7) and the pressing device (8) explained below are arranged in the embodiment being shown at the carriage (22) and can be fed via said carriage to the workpiece (4). As an alternative, a stationary arrangement at the frame (6) is possible.

The pressing device (8) is used to apply a controlled pressing force or clamping force (F) to the workpiece (4) or at least to a workpiece part (13) and to press said workpiece at a suitable point in the immediate or farther vicinity of the working point or joining point (15).

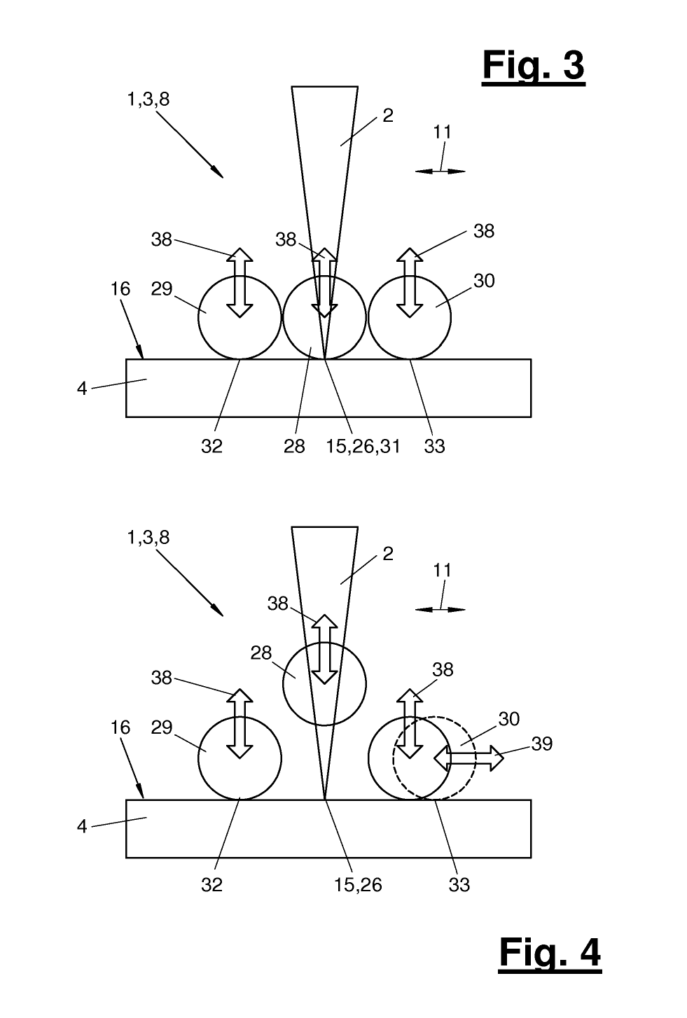

As is illustrated in schematic views in FIGS. 3 through 7, the pressing device (8) has a plurality of, especially two, preferably three pressing elements (28, 29, 30), which act on the workpiece (4) or the workpiece part (13). A pressing element (28) is preferably arranged, when viewed in the direction of transport (11), at the same level as and laterally transverse next to the laser beam (2). The pressing element (28) located close to the beam has a pressing point (31), which is located in the immediate vicinity of the working or joining point (15) and migrates with same during the feed of the working tool (3).

The pressing element (8) has at least one additional pressing element (29, 30), which is arranged in the direction of transport (11) in front of and/or behind the pressing element (28) that is located close to the beam. This configuration may be designed in different ways.

In the exemplary embodiment shown, the pressing device (8) has three pressing elements (28, 29, 30). The pressing element (28) located close to the beam is arranged centrally, and another peripheral pressing element (29, 30) each is arranged in front of and behind it in the direction of transport (11). The pressing elements (28, 29, 30) are arranged on the same side of the workpiece (4) and act on the workpiece (4) with a pressing force (F) from the same direction, preferably in the perpendicular direction or in a slightly oblique position. In addition, additional pressing elements acting on the other side of the workpiece may be present as needed. The pressing elements (28, 29, 30) are preferably arranged flush in one row one after another in the direction of transport (11).

The pressing function of at least one pressing element (28, 29, 30) can be activated or deactivated and exert said pressing force (F) on the workpiece (4) or at least on a workpiece part (13) in case of activation. The pressing force (F) becomes ineffective in case of deactivation. The activation/deactivation may be effected by a motion and/or the application of a force of the pressing element or pressing elements (28, 29, 30).

The pressing elements (28, 29, 30) can be moved for this by means of a controllable infeed device (38) between a pressing position at the workpiece (4) and an inoperative position that is located at a spaced location therefrom. These pressing elements (28, 29, 30) can be moved individually by means of a controllable infeed device (38) between their pressing position and inoperative position. All these pressing elements (28, 29, 30) can preferably be fed and moved individually and independently from one another in the above-mentioned manner.

The infeed device (38) may have any desired and suitable design, e.g., it may be designed as a pneumatic or hydraulic cylinder, as an electric motor-driven spindle or toothed rack drive or the like. The infeed device (38) may be controllable by means of a control not shown, e.g., the robot control. The feed may also take place in a regulated manner by means of a suitable sensor system, e.g., a sensor system detecting the force or displacement. The pressing element or pressing elements (28, 29, 30) can be adapted to the workpiece (4) in the pressing position with a controllable, preferably regulatable pressing force (F). This force may be applied by the adjusting device (41) and/or the respective corresponding infeed device (38).

The infeed device (38) is indicated symbolically by a vertical double arrow in FIGS. 3 through 7. The respective pressing element (28, 29, 30) may be locked in the pressing and inoperative positions.

A controllable infeed device (38) of its own may be associated with each pressing element (28, 29, 30). It is possible in another embodiment to associate a common controllable infeed device (38) to a plurality of pressing elements (29, 30), e.g., to the two peripheral pressing elements (29, 30). This may be designed, e.g., as a rotatable bearing yoke. As a result, the pressing elements (29, 30) can be moved mutually alternatingly in their pressing and inoperative positions. When, for example, the other peripheral pressing element (29) assumes the pressing position, the other peripheral pressing element (30) is lifted off into the inoperative position. The pressing elements (28, 29, 30) are each located at a spaced location from the workpiece (4) in the inoperative position.

As is schematically indicated in FIG. 4 in a view drawn in broken line for the right-hand peripheral pressing roller (30), a shifting device (39) may be associated with one or more pressing elements (28, 29, 30) for changing the position of the element in the direction of transport (11) and along the workpiece (4) or the working path (16). The two peripheral pressing elements (29, 30) preferably have such a shifting device (39). The shifting device (39) may likewise be connected to the control.

There are different possibilities for the design embodiment of the pressing element or pressing elements (28, 29, 30). The pressing elements (28, 29, 30) may have each an identical design or different designs.

In the exemplary embodiments shown, the pressing elements (28, 29, 30) are designed each as rotatable pressing rollers with an axis of rotation extending at right angles to the direction of transport, which rollers roll on the surface of the workpiece in the pressing position. The pressing rollers (28, 29, 30) may have identical or different shapes and dimensions, especially diameters. The pressing roller (28) located close to the beam may be, e.g., larger than the other pressing rollers (29, 30).

In another embodiment, the pressing element or pressing elements (28, 29, 30) may be designed as pressing fingers with sliding contact on the surface of the workpiece. In addition, there are other desirable design embodiments.

One or more and preferably all pressing elements (28, 29, 30) consist of a heat-resistant material that is stable during the process, especially metal. They preferably consist of steel. As a result, they are not modified, especially deformed, by the process heat at the working point (15) in an unacceptable manner. In addition, they are resistant to other effects of the process, e.g., blobs of melted solder or melted filler metal, vapors, liquids or the like.

FIGS. 3 through 7 show different operating positions of the pressing device (8).

In the variant according to FIG. 3, all three roller-shaped pressing elements (28, 29, 30) are activated and in the working position and contact the surface of the workpiece at three local and, e.g., punctiform pressing points (31, 32, 33). As a result, the workpiece (4) and the workpiece parts (12, 13) are acted on and pressed with a pressing force (F) not only at the working point (15), but also at the areas located in front of and behind it in the direction of transport.

FIG. 4 illustrates an operating position that is favorable for the inner or central area of a working path (16). The pressing element (28), which is located close to the beam and is, e.g., the central pressing element, is located in the deactivated or possibly lifted-off inoperative position, and the other two peripheral pressing elements (29, 30) are activated and are in the pressing position and are located with their pressing points (32, 33) at a spaced location from the current working point (15) in the direction of transfer (11). A broadened clamping area, which extends over the working point (15) and in which any possible workpiece tolerances or workpiece deformations can be compensated, so that a joint seam (16) of the specified shape will become established, is formed between the spaced-apart pressing points (32, 33). This shape can be free from undesired warping or other, optically visible anomalies.

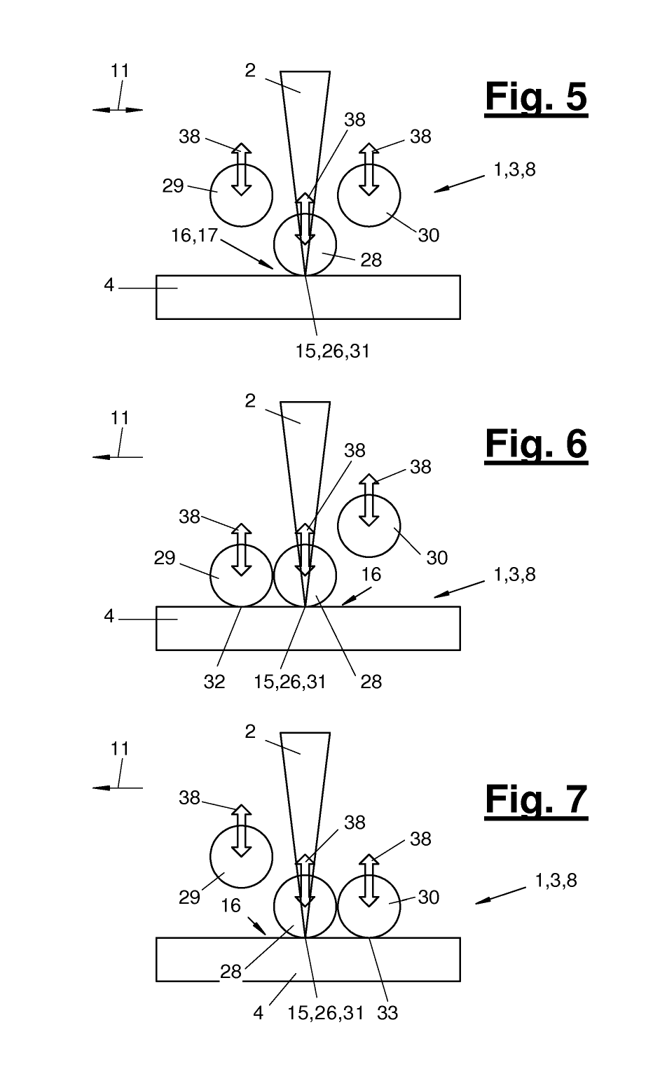

FIG. 5 shows an operating position, in which the central pressing element (28) is activated and assumes the pressing position, and the peripheral pressing elements (29, 30) are deactivated and are located in the lifted-off inoperative position. This operating position and the pressing and clamping of the workpiece (4) or of the workpiece parts (12, 13) directly next to the working or joining point (15) may be meaningful and advantageous at the beginning and the end (17) of a working path (16) and also at other areas of the path, e.g., at bend or kink points in order to create a reliable joint here. It may also be advantageous and meaningful for other joining tasks and seam shapes.

It is then possible to change over from the operating position according to FIG. 5 to the operating position according to FIG. 4 in the further course of the feed of the working tool (3), in which case the pressing element (28) located close to the beam is deactivated and lifted off into the inoperative position and the other pressing elements (29, 30) are activated and fed into the pressing position.

FIG. 6 shows a variant of the operating position. The pressing element (28) located close to the beam and the pressing element (29) located in front of it in the direction of transport (11) and in the farther extension of the working path (16) are activated and in the pressing position with the two pressing points (31, 32) in this case. The third and rear pressing element (30) is deactivated and in the lifted-off inoperative position in this case. The limitation to two activated pressing elements (28, 29) may be advantageous for curved working paths. The selective lifting-off of a pressing element (28, 29, 30) may also be advantageous for evading obstacles.

FIG. 7 illustrates a reversed operating position compared to FIG. 6 with activation and feed into the working position of the pressing element (28), which is located close to the beam and is the central pressing element, and of the pressing element (30) located behind it in the direction of transport (11). The front pressing element (29) in the direction of feed is deactivated and lifted off into the inoperative position.

In the embodiments shown in FIGS. 3 through 7, the pressing elements (28, 29, 30) perform a feed motion by means of the infeed device(s) (38). The pressing force (F) can be applied by the adjusting device (41) in a controlled or possibly regulated manner for all the pressing elements (28, 29, 30) that are located in the working position and are locked and supported there.

In another embodiment, the pressing force (F) of the adjusting device (41) and the respective infeed device (38) may be applied together. Another variant makes provisions for the application of force by the respective infeed device (38) only. This is also suitable for working tools (3) without carriage (22) or a similar adjusting axle and without adjusting device (41).

Furthermore, a significant feed motion of the pressing elements (28, 29, 30) may be eliminated in another embodiment, and the infeed device(s) (38) is/are controllable force generating devices, with which the pressing force (F) can be switched on or off.

One or more pressing rollers (28, 29, 30) may have a rotating drive (34). It drives the particular pressing roller (28, 29, 30) to which force is being applied synchronously with the rolling motion thereof, which is due to the feed.

In the embodiment shown, the rotating drive (34) is designed as a mechanical rotating drive and as a rotating drive whose drive motion is derived from the feed motion in another way. This rotating drive has at least one friction roller (35), which contacts the workpiece (4) in a frictionally engaged manner and which has a corresponding design favorable for friction at the contact point with the workpiece (4) and has, e.g., a jacket consisting of plastic or the like with a high coefficient of friction and a certain flexibility or elasticity. It may be located at a more widely spaced location from the working point (15) or the working path (16) in the transverse direction than the corresponding pressing roller (28, 29, 30) in a rotationally engaged manner via an axis connection (36).

The friction roller (35) is coupled with at least one associated pressing roller (28, 29, 30). In the exemplary embodiment being shown, the friction roller (35) is coupled directly with a single pressing roller via a common axis (36). The axis connection (36) may have, as an alternative, a gear-like distribution, so that a friction roller (35) may be coupled with a plurality of pressing rollers (28, 29, 30) in a rotationally engaged manner.

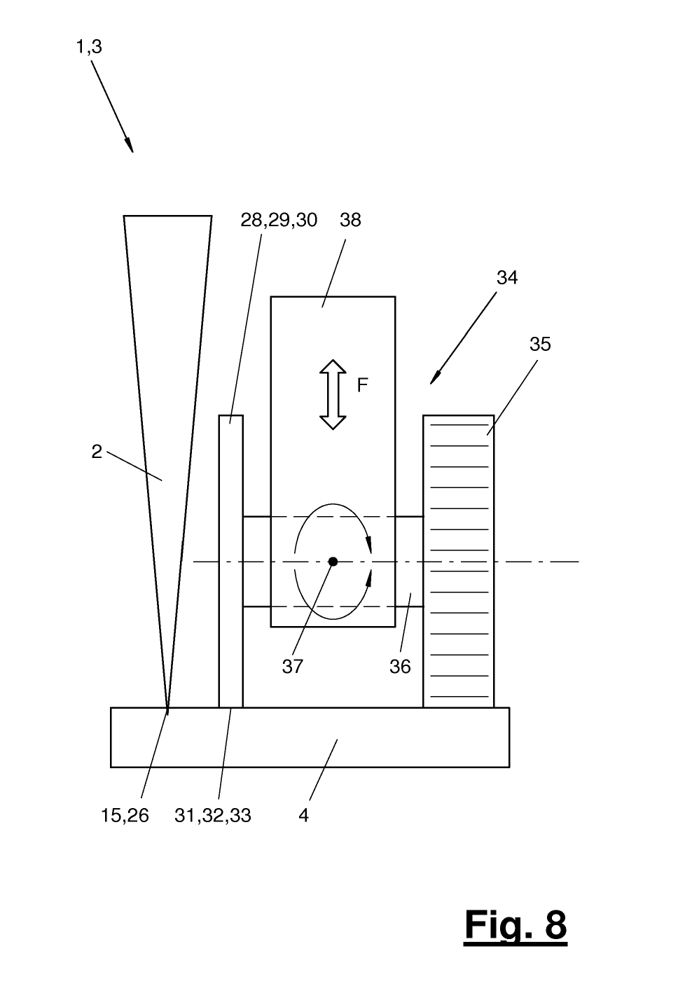

As is shown in FIG. 8, the axis connection (36) may also be coupled with an infeed device (38), with which said rollers, which are preferably arranged on both sides thereof, are fed and pressed to the surface of the workpiece. The axis connection (36) may have a pivot bearing (37) shown in FIG. 8 in order to ensure uniform pressing of the rollers (28, 29, 30, 35) connected to the axis connection (36).

Different variants of the embodiments shown and described are possible. The pressing device (8) may have a different number of pressing elements (28, 29, 30). Only two pressing elements may be present in one variant. These may be, e.g., the pressing element (28) located close to the beam and another pressing element, which is arranged in front of or behind the pressing element (28) located close to the beam in the direction of transport (11). In another variant, the pressing element (28) located close to the beam may be eliminated, and the other two pressing elements (29, 30) are arranged at spaced locations in front of and behind the laser beam or the working point (15). Further, it is possible to equip a pressing device (8) with four, five or more pressing elements (28, 29, 30).

It is possible in another variant to make a pressing element, especially a pressing roller, from a more heat-sensitive material, and said pressing element is screened by a heat-insulating screen from the laser beam (2) and the working point (15) to reduce the thermal effects of the process. It may also be located at a greater distance from this point (15). It is, furthermore, possible in case of such a design to eliminate a rotating drive (34) and to design a pressing roller (28, 29, 30) as a friction roller with a corresponding material that is favorable for friction. This may also be provided in only one driving roller in case of multiple pairs, and this pressing roller is then also designed as a friction roller of a correspondingly redesigned rotating drive for the other pressing rollers.

As an alternative, the rotating drive (34) may have a contoured driving roller for a positive-locking action on a correspondingly designed workpiece surface. The rotating drive (34) nay be designed in another variant as a drive that can be controlled and possibly regulated with a motor and connected to said control. The rotating drive (34) may also be eliminated.

The beam (2) may have a different design. It may be, e.g., an ion beam or a plasma beam. A beam (2) may be emitted constantly or in a pulsed manner. It may also be split, if needed, into a plurality of partial beams.

The working apparatus (1) and the working tool (3) may also be used for other working processes with a high-energy beam (2). This may be, e.g., a cutting process or a material removal process with the beam (2). Furthermore, other joining processes, e.g., welding, bonding or the like, may be used. The energy of the beam (2) impacting on the workpiece (4) and the heat introduced thereby into the workpiece (4) may also be used for any other desired heat treatments of the workpiece (4).

Further, it is possible to combine the features of the above-described exemplary embodiments and the variants thereof with one another in different ways and possibly also to exchange them.

While specific embodiments of the invention have been shown and described in detail to illustrate the application of the principles of the invention, it will be understood that the invention may be embodied otherwise without departing from such principles.

1. A working apparatus, for working a workpiece with a high-energy beam, the working apparatus comprising:
a working tool, movable in a direction of transport, with a working head emitting the beam; and further comprising
a pressing device comprising:
a pressing element arranged at a level of and to at a side of the beam; and
an additional pressing element arranged adjacent to the pressing element and located close to the beam in the direction of transport, wherein the pressing element and the additional pressing element are on a same side of the workpiece and act in a same direction upon the workpiece.

2. A working apparatus in accordance with claim 1, wherein:
the pressing device further comprises a further pressing element to provide three pressing elements;
the pressing element comprises a central pressing element located close to the beam; and
the additional pressing element and the further pressing element comprise additional peripheral pressing elements being arranged in front of and behind the central pressing element located close to the beam.

3. A working apparatus in accordance with claim 1, wherein the pressing elements are arranged flush one after another in a row.

4. A working apparatus in accordance with claim 1, wherein the pressing elements can be activated or deactivated individually and preferably independently from one another for pressing a one-part or multipart workpiece with a clamping force.

5. A working apparatus in accordance with claim 1, wherein:
the pressing elements are mounted to be fed into a pressing position at the workpiece for activation and pressed with a clamping force; and
the pressing elements can be moved into a pressing-free inoperative position for deactivation or are left in the pressing position in which the force can be switched off.

6. (canceled)

7. A working apparatus in accordance with claim 1, further comprising a controllable infeed device wherein one or more pressing elements can be moved by the controllable infeed device between a pressing position at the workpiece and an inoperative position located at a spaced location therefrom.

8. (canceled)

9. A working apparatus in accordance with claim 1, further comprising a controllable infeed device associated with each pressing element.

10. A working apparatus in accordance with claim 1, further comprising a common controllable infeed device, with which the pressing elements are moveable mutually alternatingly into the a pressing position and an inoperative position, wherein the pressing elements are pressable onto the workpiece with a controllable regulatable pressing force in the pressing position.

11. (canceled)

12. A working apparatus in accordance with claim 2, wherein one or both of the additional pressing elements, have a shifting device for changing position in the direction of travel.

13. A working apparatus in accordance with claim 2, wherein when tracking a working path on the workpiece, in the central area of the path, the central pressing element located close to the beam is deactivated and the peripheral pressing elements are activated.

14. A working apparatus in accordance with claim 1, wherein when tracking a working path on the workpiece, especially a joint seam, at the end area of the path, at least the central pressing element is activated.

15. A working apparatus in accordance with claim 1, wherein one or more of the pressing elements consist of a heat-stable metal material.

16. A working apparatus in accordance with claim 1, wherein the pressing elements are configured as rotatable pressing rollers.

17. A working apparatus in accordance with claim 16, wherein the pressing rollers have a rotating drive.

18. A working apparatus in accordance with claim 17, further comprising a controllable infeed device wherein one or more of the pressing elements is moveable by the controllable infeed device, wherein the rotating drive has a friction roller, which contacts the workpiece and is coupled with an associated pressing roller in a rotationally engaged manner via an axis connection and the axis connection is coupled with the infeed device.

19. (canceled)

20. (canceled)

21. (canceled)

22. A working apparatus in accordance with claim 21, further comprising:
a movable carriage for receiving the working head and the pressing device; and
an adjusting device for the carriage, the moveable carriage and the adjusting device being arranged at the frame.

23. A working apparatus in accordance with claim 22, further comprising a controllable infeed device wherein one or more of the pressing elements is moveable by the controllable infeed device, wherein the pressing force of the pressing elements is generated by the adjusting device or the infeed device or is generated by both the adjusting device and the infeed device.

24. (canceled)

25. A working apparatus in accordance with claim 1, wherein the working tool has an oscillating device for an oscillating motion of the beam, which motion is directed at right angles to the direction of transport.

26. A working apparatus in accordance with claim 1, wherein the working tool has a sensor system for guiding or for testing or for both guiding and testing.

27. (canceled)

28. A working apparatus in accordance with claim 1, wherein the working apparatus has a multiaxially movable manipulating device comprising an articulated industrial robot with working tool connected thereto.

29. (canceled)
